(19) United States
(12) Patent Application Publication
(10) Pub. No.: US 2012/0229937 A1
(43) Pub. Date: Sep. 13, 2012

(54) HIGH CURRENT DC SWITCHING CONTROLLER WITH FAULT MONITORING

(75) Inventors: Gautham Ramamurthy, Bangalore (IN); Manjunath Sreenivasaiah, Bangalore (IN); Chandrashekar Srinivas, Bangalore (IN); Guruprasad Krishnamurthy, Bangalore (IN); Girish Krishnaiah, Bangalore (IN)

(73) Assignee: HONEYWELL INTERNATIONAL INC., Morristown, NJ (US)

(21) Appl. No.: 13/043,513

(22) Filed: Mar. 9, 2011

(51) Int. Cl. H02H 7/00; H05B 3/10

(52) U.S. Cl. 361/18; 219/552

(57) ABSTRACT

A system includes a control switch and a control module. The control switch is configured to drive current through an electrical load in a closed state, and disconnect the electrical load from a power supply in an open state. The control module is configured to connect to a thermostat switch that operates in one of an open state or a closed state based on a temperature of the thermostat switch. The control module is further configured to control a state of the control switch based on a state of the thermostat switch and detect a fault in the control switch based on the state of the thermostat switch and a voltage across the control switch.

### TECHNICAL FIELD

The disclosure relates to switching controllers, and, more particularly, to high wattage switching controllers including fault monitoring functionality.

### BACKGROUND

Temperature control systems, such as heating systems, air conditioning systems, or refrigeration systems, to name a few, may be used to control ambient temperature. Temperature control systems may include thermostat switches that indicate the ambient temperature relative to a set-point temperature of the thermostat switch. In some examples, a thermostat switch may include a bimetallic switch and/or mercury switch that indicates the ambient temperature. A temperature control system that includes a thermostat switch may provide heating/cooling to control the ambient temperature based on the state of the thermostat switch.

Some temperature control systems provide heating or cooling using devices that draw relatively high currents (e.g., in the range of tens of amperes). For example, such devices may include resistive heaters, boilers, furnaces, or air conditioning units. In some examples, temperature control systems include thermostat switches that detect the ambient temperature, while another device, e.g., a relay or semiconductor device, controls current through the heating/cooling device. In other examples, the current used to control the heating/cooling device may be drawn through the thermostat switch itself, depending on the amount of switching current used by a the particular heating/cooling device.

### SUMMARY

A control system according to the present disclosure controls current delivered to an electrical load (e.g., a resistive heater) based on a state of a thermostat switch. In one example, the control system includes a circuit that controls the state of a control switch (e.g., a transistor) that regulates current delivered to the electrical load based on the state of the thermostat switch.

The control system includes a fault detection circuit that detects a fault (e.g., a short or open circuit) in the control switch based on the state of the thermostat switch and a voltage across the control switch. When the fault detection circuit detects the fault in the control switch, the control system may blow a fuse to disconnect power from the electrical load and set a fault indicator that indicates to a user that a fault has occurred in the control switch. The control system of the present disclosure may be implemented using low cost discrete circuit components.

In some examples, the present disclosure is directed to a system comprising a control switch and a control module. The control switch is configured to drive current through an electrical load in a closed state, and disconnect the electrical load from a power supply in an open state. The control module is configured to connect to a thermostat switch that operates in one of an open state or a closed state based on a temperature of the thermostat switch. The control module is further configured to control a state of the control switch based on a state of the thermostat switch and detect a fault in the control switch based on the state of the thermostat switch and a voltage across the control switch.

In other examples, the present disclosure is directed to a system comprising a transistor and a circuit. The transistor is configured to connect to an electrical load, drive current through the electrical load in a closed state, and disconnect the electrical load from a power supply in an open state. The circuit is configured to connect to a thermostat switch that operates in one of an open state or a closed state based on a temperature of the thermostat switch. The circuit is further configured to provide a control voltage to the transistor based on a state of the thermostat switch. The control voltage sets the state of the transistor. Additionally, the circuit is configured to detect a fault in the transistor based on the state of the thermostat switch and a voltage drop across the transistor.

In other examples, the present disclosure is directed to a method comprising determining a state of a thermostat switch that operates in one of an open state or a closed state based on a temperature of the thermostat switch. The method further comprises setting a state of a control switch based on the determined state of the thermostat switch. The control switch drives current through an electrical load in a closed state, and the control switch disconnects the electrical load from a power supply in an open state. The method further comprises detecting a fault in the control switch based on the determined state of the thermostat switch and a voltage across the control switch.

The details of one or more examples are set forth in the accompanying drawings and the description below. Other features, objects, and advantages will be apparent from the description and drawings, and from the claims.

### BRIEF DESCRIPTION OF THE DRAWINGS

FIG. 1 is a block diagram of a cabinet that includes cabinet electronics and temperature control components used to heat the inside of the cabinet.

FIG. 2 is a flow diagram of an example method for controlling a heater included in the cabinet of FIG. 1 and detecting a fault in a control switch used to control current to the heater.

FIG. 3 is a schematic of an example circuit representing the electrical components included in the cabinet of FIG. 1.

FIG. 4 is a table that summarizes the operation of the circuit of FIG. 3.

FIG. 5 is a schematic that includes an example fault indicator circuit that may connect to the circuit of FIG. 3 to indicate a detected fault in a control switch.

FIG. 6 is a block diagram of an example packaging arrangement of electrical components included in the circuit of FIG. 3.

FIGS. 7A and 7B show three-dimensional views of an example enclosure that includes components of the circuit of FIG. 3.

### DETAILED DESCRIPTION

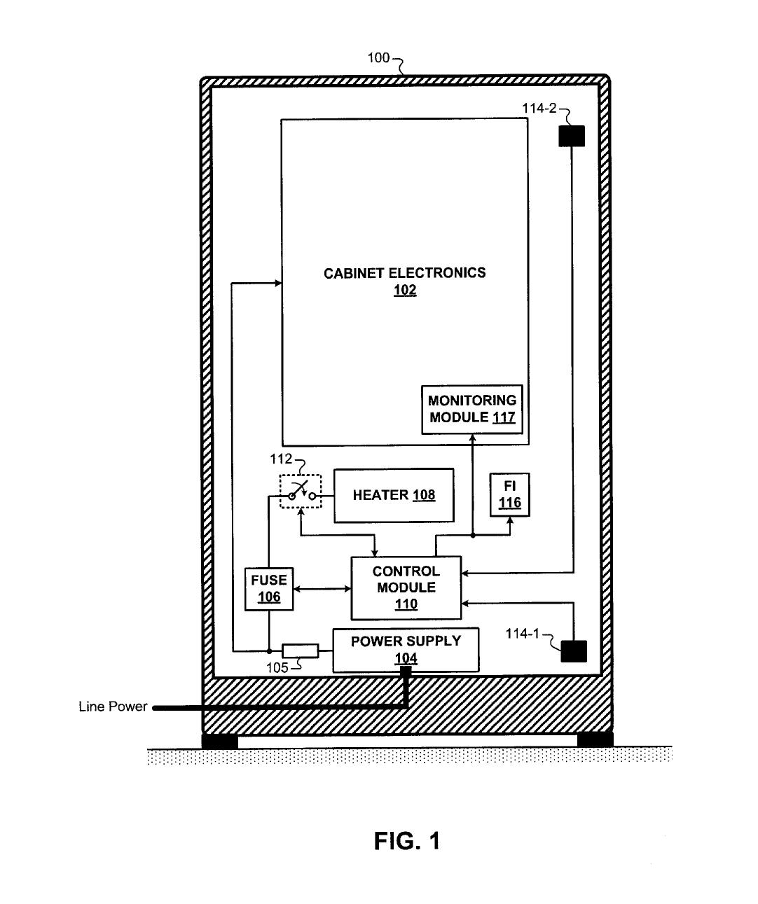

FIG. 1 is a block diagram of a cabinet 100 that includes cabinet electronics 102. Cabinet 100 may represent any general enclosure that may be used to house various electronic components, for example, to protect the electronic components from the environment. In some examples, cabinet 100 may be a metal enclosure that is configured to house electronic telecommunication components, such as optical waveguide grating devices, fiber optic multiplexers, and signal amplification circuitry. Cabinet electronics 102 included in cabinet 100 may generally represent the electronic telecommunication components included in cabinet 100. Although cabinet electronics 102 may represent telecommunication components, cabinet electronics 102 may represent other electronic components that may be housed within cabinet 100.

Cabinet 100 may include a power supply 104 that provides power to cabinet electronics 102 through a fuse 105. In some examples, power supply 104 may include an electrical adapter (e.g., AC/DC converter) that receives AC voltage from line power (e.g., 120/240VAC) and outputs DC voltage/current (e.g., 5V, 12V, 24V, or other voltages). In other examples, power supply 104 may include a battery that outputs voltages ranging from 5-24VDC or greater. In still other examples, power supply 104 may include both an electrical adapter and a battery as described above. In these examples, power supply 104 may provide voltage/current via the electrical adapter and/or the battery. Additionally, in these examples, the battery may be charged by the electrical adapter. Fuse 105 may blow when cabinet electronics 102 or other electronic components in cabinet 100 (e.g., heater 108) malfunction, or otherwise draw greater than a typical operating current. When fuse 105 is blown, some or all of the electronic components within cabinet 100 may be disconnected from power supply 104.

Cabinet 100 may be located in an environment in which temperatures may fluctuate. In some examples, cabinet 100 may be located indoors, and cabinet 100 may be heated or cooled by the room in which cabinet 100 is placed and may not be subject to wide variations in temperature. In other examples, cabinet 100 may be located outdoors. When located outdoors, cabinet 100 may be heated by the environment, e.g., heated by the sun, air, and/or the surface on which cabinet 100 rests. Cabinet 100 may also be cooled by the environment, e.g., by air, precipitation, and/or the surface on which cabinet 100 rests. Cabinet 100 and cabinet electronics 102 may tend to fluctuate in temperature along with the fluctuating environmental temperatures.

Cabinet electronics 102 may be configured to operate within a range of operating temperatures. The range of operating temperatures may be defined by a minimum operating temperature and a maximum operating temperature. The range of operating temperatures may generally define a range of desired temperatures at which cabinet electronics 102 are designed to function correctly. At temperatures outside of this range of desired temperatures, e.g., less than the minimum operating temperature or greater than the maximum operating temperature, cabinet electronics 102 may function incorrectly or be more prone to malfunction.

Since components (e.g., cabinet electronics 102) included in cabinet 100 may fluctuate in temperature along with the environment, cabinet electronics 102 may potentially reach a temperature that is less than the minimum operating temperature or greater than the maximum operating temperature, depending on the temperature of the environment in which cabinet 100 is placed. For example, during winter, cabinet electronics 102 may potentially drop to a temperature below the minimum operating temperature. Subsequently, during summer, cabinet electronics 102 may potentially reach a temperature that is greater than the maximum operating temperature.

Cabinet 100 may include environmental control components that regulate the environment within cabinet 100 so that the temperature within cabinet 100 does not fluctuate outside the range of operating temperatures for cabinet electronics 102. For example, environmental control components may include temperature control components such as a heater 108 that is used to heat the inside of cabinet 100. In some examples, heater 108 may comprise wires sandwiched between two layers of silicone that are in turn mounted on a metal plate. Driving current through the wires may heat the wires, the metal plate, and the inside of cabinet 100.

In some examples, cabinet 100 may include environmental control components other than heater 108 that regulate the temperature and/or environment inside cabinet 100. For example, cabinet 100 may include a cooling device (e.g., a refrigeration device) used to cool the inside of cabinet 100. Additionally, or alternatively, cabinet 100 may include a fan used to circulate air within cabinet 100. In some examples, cabinet 100 may include a dehumidifier that regulates the level of humidity within cabinet 100. In still other examples, cabinet 100 may include devices other than the environmental control components described above. For example, cabinet 100 may include an actuator (e.g., an electric motor) that actuates other components included within cabinet 100 or outside of cabinet 100. These environmental control components described above, e.g., heater 108, cooling device, fan, and actuator, included in cabinet 100, may receive power from power supply 104 via a fuse 106.

Control module 110 controls the amount of power supplied to heater 108 by power supply 104. Control module 110 may control power supplied to heater 108 in order to maintain the temperature within cabinet 100 above the minimum operating temperature of cabinet electronics 102 so that cabinet electronics 102 may function properly in colder environments and so that condensation and ice formation on cabinet electronics 102 is prevented. In some examples, control module 110 may control power supplied to heater 108 so that cabinet electronics are maintained at a temperature between −5° C. and 10° C.

Control module 110 may include any discrete and/or integrated electronic circuit components that implement analog and/or digital circuits capable of producing the functions attributed to control module 110 herein. For example, control module 110 may include analog circuits, e.g., amplification circuits, filtering circuits, and/or other signal conditioning circuits. Control module 110 may also include digital circuits, e.g., combinational or sequential logic circuits, memory, etc. Memory may include any volatile, non-volatile, magnetic, or electrical media, such as a random access memory (RAM), read-only memory (ROM), non-volatile RAM (NVRAM), electrically-erasable programmable ROM (EEPROM), Flash memory, or any other memory device. Furthermore, memory may include instructions that, when executed by one or more processing circuits of control module 110, cause control module 110 to perform various functions attributed to control module 110 herein.

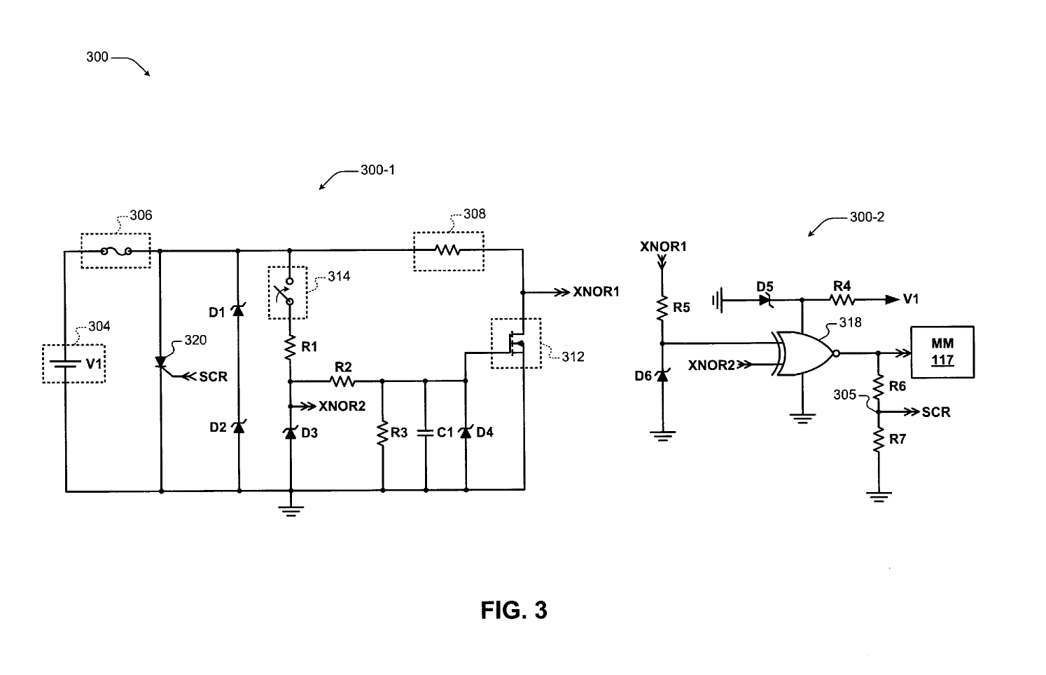

Control module 110 may control a control switch 112 in order to control power supplied to heater 108. For example, control switch 112 may include a metal-oxide-semiconductor field-effect transistor (MOSFET), as illustrated in FIG. 3. Control module 110 may close control switch 112 to connect heater 108 to power supply 104 such that heater 108 conducts current and heats the inside of cabinet 100. In some examples, control switch 112 may be capable of high current switching, in the range of tens of amperes, e.g., 15 A or more. Control module 110 may also open control switch 112 to disconnect heater 108 from power supply 104 so that heater 108 does not conduct current, and therefore ceases to heat the inside of cabinet 100. In other examples, control module 110 may operate control switch 112 in a continuous manner instead of a discrete on/off manner. For example, when control switch 112 includes a MOSFET switch, control module 110 may vary an amount of voltage at the gate of the MOSFET to vary a current through heater 108, thereby controlling heater 108 in a continuous manner, as opposed to controlling heater 108 using a discrete on/off voltage. Details regarding operation of an example control switch 112 are described below with respect to FIG. 3.

Control module 110 may control power supplied to heater 108 based on the temperature within cabinet 100 as indicated by thermostat switches 114-1, 114-2 (collectively “thermostat switches 114”). Thermostat switches 114 may represent any switching device that may be used to indicate the temperature inside of cabinet 100. Thermostat switches 114-1, 114-2 may indicate temperatures inside of cabinet 100 at the location of thermostat switches 114-1, 114-2, respectively. Although two thermostat switches 114 are illustrated in FIG. 1, in some examples, only a single thermostat switch may be included in cabinet 100. In other examples, more than two thermostat switches may be included in cabinet 100.

Thermostat switches 114 may indicate temperature in a discrete manner. For example, thermostat switches 114 may operate in a one of a closed or open state, depending on the temperature of thermostat switches 114. Thermostat switches 114 may include, for example, a bimetallic switch that forms a closed circuit or an open circuit based on the temperature of the bimetallic switch (e.g., the ambient temperature).

Each of thermostat switches 114 may operate according to a set-point temperature. For example, thermostat switch 114-1 may close to form a short circuit when the temperature of thermostat switch 114-1 drops to less than the set-point temperature. Thermostat switch 114-1 may open to form an open circuit when thermostat switch 114-1 is heated to a temperature that is greater than the set-point temperature. Accordingly, the state of thermostat switches 114, e.g., whether thermostat switches 114 are in an open state or a closed state, may indicate to control module 110 whether the temperature within cabinet 100 is greater than or less than the set-point temperature.

The set-point temperatures of thermostat switches 114 may be set (e.g., by a user or manufacturer) so that the temperature within cabinet 114 is maintained within the operating temperature of cabinet electronics 102. For example, the set-point temperatures of thermostat switches 114 may be set so that thermostat switches 114 will close in response to a temperature that is greater than a minimum operating temperature of cabinet electronics 102 and open in response to a temperature that is less than the maximum operating temperature of cabinet electronics 102. In some examples, the set-point temperatures of thermostat switches 114 may be set within a range of −5° C.-10° C.

In some examples, thermostat switches 114 may exhibit a region of hysteresis around the set-point temperature, and therefore, thermostat switches 114 may not open and close at a single temperature, but instead may open and close at different temperatures depending on whether thermostat switches 114 are being cooled to a temperature that is less than the set-point temperature or heated to a temperature that is greater than the set-point temperature. This region of hysteresis may prevent excessive switching of thermostat switches 114. In some examples, thermostat switches 114 may be configured to open at approximately 10° C. and may close at approximately −5° C.

Temperatures may vary within cabinet 100, depending on the location within cabinet 100. Cabinet electronics 102 may generate heat, and, therefore, temperatures near cabinet electronics 102 may be relatively greater than temperatures farther away from cabinet electronics 102. Temperatures at or near the walls of cabinet 100 may vary along with environmental temperatures. In examples where the environmental temperature is relatively warm, temperatures near the walls of cabinet 100 may be higher than temperatures further inside of cabinet 100 since the walls of cabinet 100 may be heated by the environment, e.g., heated by the sun, ground, and surrounding air. In examples where the environmental temperature is relatively cold, temperatures near the walls of cabinet 100 may be lower than temperatures further inside of cabinet 100 since the walls of cabinet 100 may be cooled by the environment, e.g., cooled by the ground and surrounding air. Since temperatures within cabinet 100 may vary depending on the location within cabinet 100, in some examples, a single thermostat switch within cabinet 100 may not indicate an accurate overall temperature within cabinet 100, but instead may only indicate a local temperature within cabinet 100 that may not be representative of the temperature experienced by cabinet electronics 102. In these examples, a plurality of thermostat switches 114 may be arranged within cabinet 100 such that thermostat switches 114 as a whole may indicate a temperature that is indicative of the temperature within cabinet 100.

Control module 110 may control power supplied to heater 108 based on the states of thermostat switches 114. For example, control module 114 may close control switch 112 to connect heater 108 to power supply 104 when the temperature within cabinet 100 is less than the set-point temperature in order to increase the temperature within cabinet 100 to a temperature nearer to the set-point temperature. In other words, control module 110, in response to one or more closed thermostat switches 114, may close control switch 112 to connect heater 108 to power supply 104. Control module 110 may open control switch 112 to disconnect heater 108 from power supply 104 when the temperature within cabinet 100 is greater than the set-point temperature in order to allow the temperature within cabinet 100 to decrease to a temperature nearer to the set-point temperature. In other words, control module 110, in response to one or more open thermostat switches 114, may open control switch 112 to disconnect heater 108 from power supply 104.

It is possible that control switch 112 can malfunction. In some examples, control switch 112 may form a permanent short circuit such that control switch 112 cannot be opened. In these examples, control switch 112 can remain shorted even when control module 110 signals control switch 112 to open. When permanently shorted, control switch 112 may permanently connect heater 108 to power supply 104, regardless of the state of thermostat switches 114, since signals from control module 110 may not open control switch 112. A permanent short circuit of control switch 112 may cause overheating of the inside of cabinet 100 since heater 108 may be continuously operated. Furthermore, components carrying current delivered to heater 108 may generate heat and be prone to damage. Continuous operation of heater 108 due to a permanent short circuit in control switch 112 may eventually lead to a drain of power from power supply 104 when power supply 104 includes a battery and, therefore, cabinet electronics 102 may cease to operate.

In other examples, control switch 112 may form a permanently open circuit such that control switch 112 may not be closed. In other words, control switch 112 may remain open even when control module 110 signals control switch 112 to close. In these examples, control switch 112 may permanently disconnect heater 108 from power supply 104, regardless of the state of thermostat switches 114, since signals from control module 110 may not close control switch 112. Inability to activate heater 108 may allow the temperature inside of cabinet 100 to decrease towards the environmental temperature. In this scenario, as described hereinafter, control module 110 may set a fault indicator 116 that indicates to a user that the contents of cabinet 100 should be inspected.

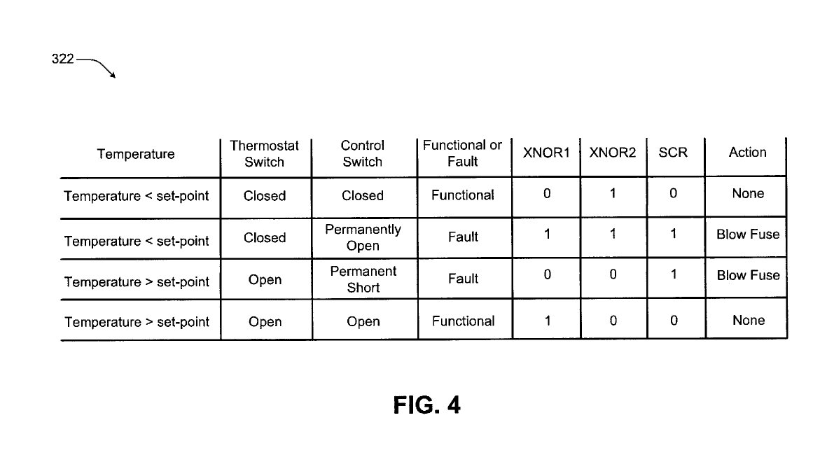

Control module 110 may detect a fault, e.g., a permanent short circuit or a permanent open circuit in control switch 112, when control switch 112 malfunctions. In response to a detected fault in control switch 112, control module 110 may disconnect power supply 104 from components included in cabinet 100. For example, control module 110 may break fuse 106 (i.e., “blow” fuse 106) upon detection of a fault in control switch 112. In one example, control module 110 may trigger a large amount of current through fuse 106, as described with respect to FIGS. 3-4, in order to blow fuse 106. Upon blowing of fuse 106, fuse 106 may act as an open circuit, and, therefore, electrical components within cabinet 100, such as heater 108, may be disconnected from power supply 104. In the case where control switch 112 is permanently shorted, blowing of fuse 106 may prevent a potential overheating of the inside of cabinet 100, electrical heating and/or damaging of components, and eventual power drain of power supply 104 when power supply 104 includes a battery. In some examples, fuse 106 may include a slow blow fuse.

In some examples, cabinet 100 may include a fault indicator 116. Fault indicator 116 may represent a device that indicates, to a user, that control module 110 has detected a fault in control switch 112. For example, fault indicator 116 may include a light, e.g., a light-emitting diode (LED), that is turned on upon blowing of fuse 106. Light emitted by the LED may indicate to a user (e.g., a person servicing cabinet electronics 102) that control module 110 has detected a fault in control switch 112 and has subsequently blown fuse 106. In other examples, fault indicator 116 may include devices other than an LED. For example, fault indicator 116 may include an alarm that audibly alerts the user that control switch 112 has malfunctioned. In still other examples, fault indicator 116 may include an audible alarm, or another type of electronic device that notifies a user of the fault, such as through a network connection (e.g., phone or Internet) so as to inform the user that control switch 112 has malfunctioned.

Control module 110 may include a fault detection circuit that detects a fault in control switch 112, e.g., a permanent open circuit or short circuit in control switch 112. The fault detection circuit may detect a fault based on the state of thermostat switches 114 and a voltage across control switch 112. The fault detection circuit included in control module 110 may determine that a fault in control switch 112 has occurred when a voltage across control switch 112 is different than an expected voltage. In one example, the fault detection circuit may detect a fault in control switch 112 when control module 110 instructs control switch 112 to open, but the fault detection circuit detects that control switch 112 is closed, e.g., based on a small voltage drop (e.g., ≈0V) across control switch 112. In another example, the fault detection circuit may detect a fault in control switch 112 when control module 110 instructs control switch 112 to close, but the fault detection circuit detects that control switch 112 is opened, e.g., based on a larger than expected voltage drop across control switch 112 (e.g., based on a voltage much greater than the ≈0V drop expected for a closed control switch 112).

In some examples, when control module 110 detects a fault in control switch 112, control module 110 may indicate to monitoring module 117 that a fault is detected. Monitoring module 117, included in cabinet electronics 102, may perform a control action in response to detection of the fault by control module 110. For example, monitoring module 117 may turn off cabinet electronics 102 when a fault is detected by control module 110.

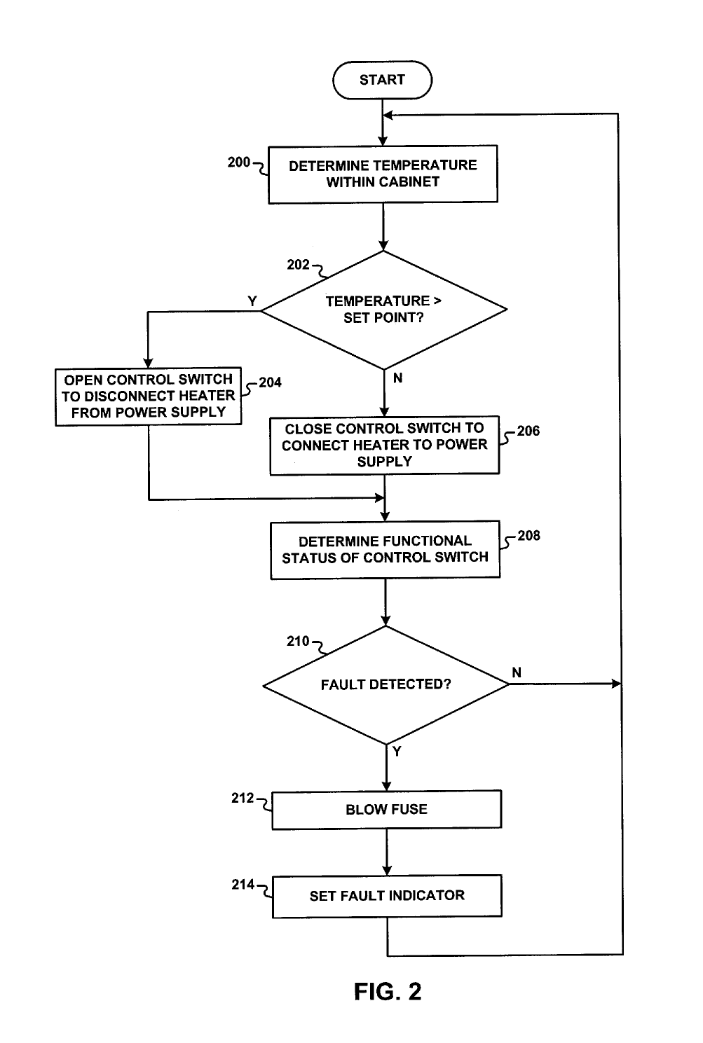

FIG. 2 is a flow diagram of an example method for controlling heater 108, detecting a fault in control switch 112, and indicating the fault in control switch 112. It may be assumed that cabinet 100 includes a single thermostat switch 114, and that there is no fault in control switch 112 at the start of the method illustrated in FIG. 2.

Initially, control module 110 determines a temperature within cabinet 100 based on a state of thermostat switch 114 included in cabinet 100 (200). For example, control module 110 may determine whether the temperature within cabinet 100 is greater than or less than the set-point temperature based on the state of thermostat switch 114. In examples where cabinet 100 includes multiple thermostat switches 114, control module 110 may determine that the temperature within cabinet 100 is greater/less than the set-point temperature when all of thermostat switches 114-1, 114-2 are in the open/closed state.

If control module 110 determines that the temperature within cabinet 100 is greater than the set-point temperature (202), control module 110 opens control switch 112 to disconnect heater 108 from power supply 104 (204). If control module 110 determines that the temperature within cabinet 100 is less than the set-point temperature (202), control module 110 closes control switch 112 to connect heater 108 to power supply 104 (206).

Control module 110 then determines the functional status of control switch 112 (208). For example, control module 110 may detect a fault in control switch 112 when the voltage across control switch 112 does not correspond to an expected voltage across control switch 112. In one example, control module 110 may detect a fault in control switch 112 when control module 110 instructs control switch 112 to open in response to an open thermostat switch 114, but then control module 110 detects that control switch 112 is closed, e.g., based on small voltage (e.g., ≈0V) drop across control switch 112. In another example, control module 110 may detect a fault in control switch 112 when control module 110 instructs control switch 112 to close in response to a closed thermostat switch 114, but then control module 110 detects that control switch 112 is opened, e.g., based on a larger than expected voltage drop across control switch 112 (e.g., based on a voltage that is greater than the ≈0V expected for a closed control switch 112).

If control module 110 does not detect a fault in control switch 112 (210), control module 110 then determines the temperature within cabinet 100 at block (200). If control module 112 detects a fault in control switch 112 (210), control module 110 blows fuse 106 (212) to disconnect power supply 104 from the electrical components (e.g., heater 108) included in cabinet 100. In some examples, subsequent to blowing fuse 106 at block (212), control module 110 may set fault indicator 116 to notify the user of the fault detected in control switch 112 (214).

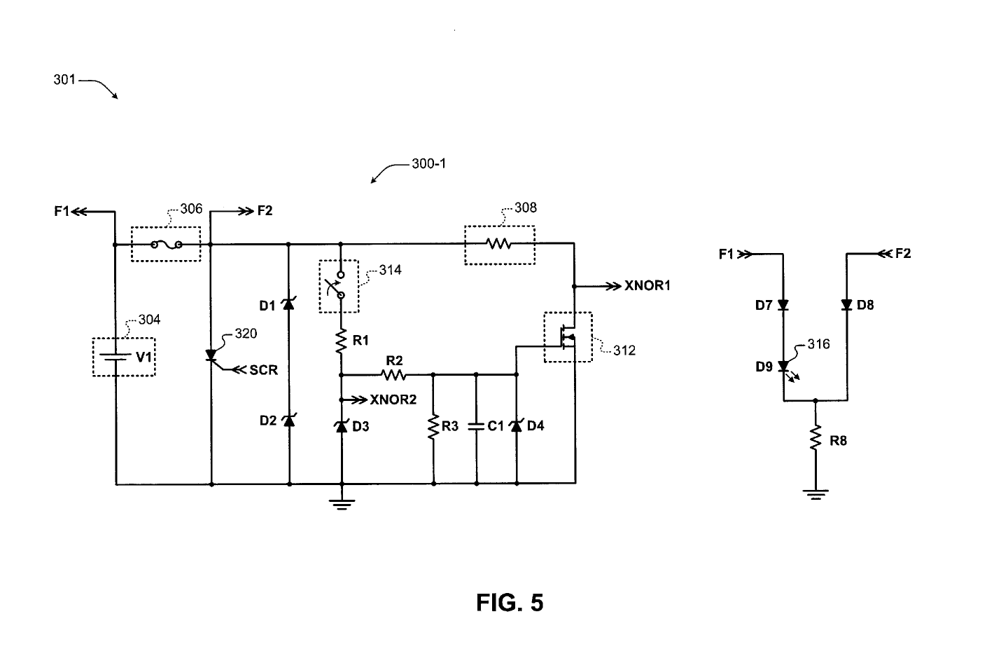

FIG. 3 is a schematic of an example circuit 300 included in cabinet 100 of FIG. 1. The dotted boxes in FIG. 3 and FIG. 5 may represent circuit elements corresponding to the functional blocks illustrated in FIG. 1. For example, power supply 302 (i.e., voltage V1) may correspond to power supply 104, fuse 306 may correspond to fuse 106, and thermostat switch 314 may correspond to one or more of thermostat switches 114. Electrical load 308, illustrated as a resistive load, may correspond to heater 108, and control switch 312 (e.g., an N-channel power MOSFET) may represent control switch 112. LED 316 may correspond to fault indicator 116. The additional circuit elements, e.g., silicon controlled rectifier (SCR) 320, resistors R1-R8, capacitor C1, diodes D1-D8, and XNOR gate 318 may represent an example control module 110.

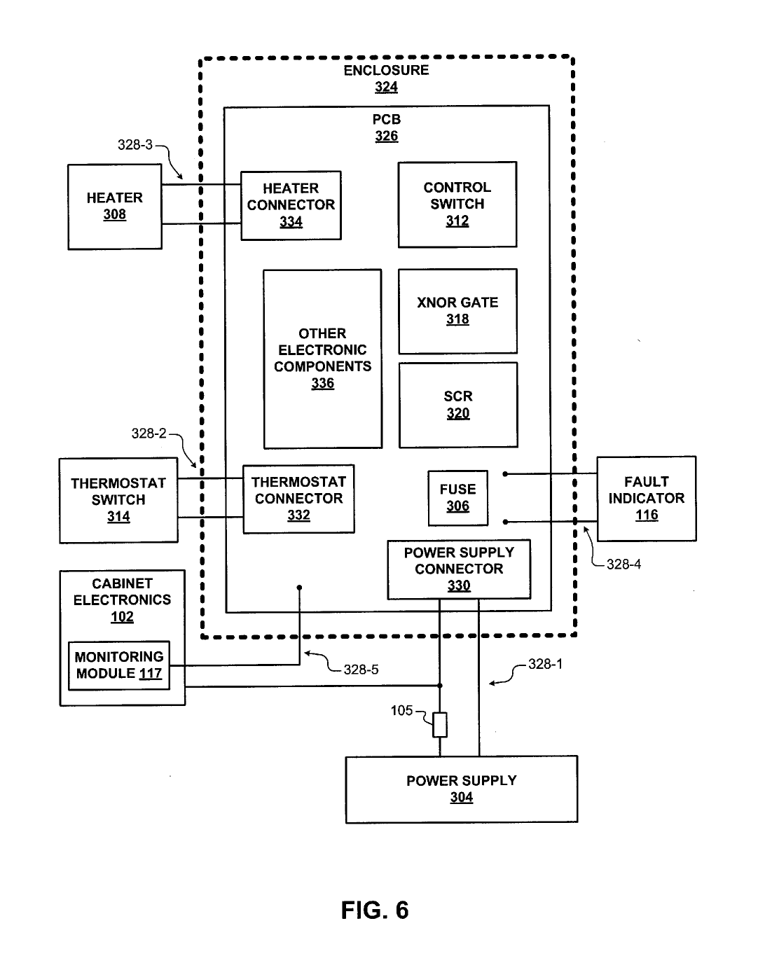

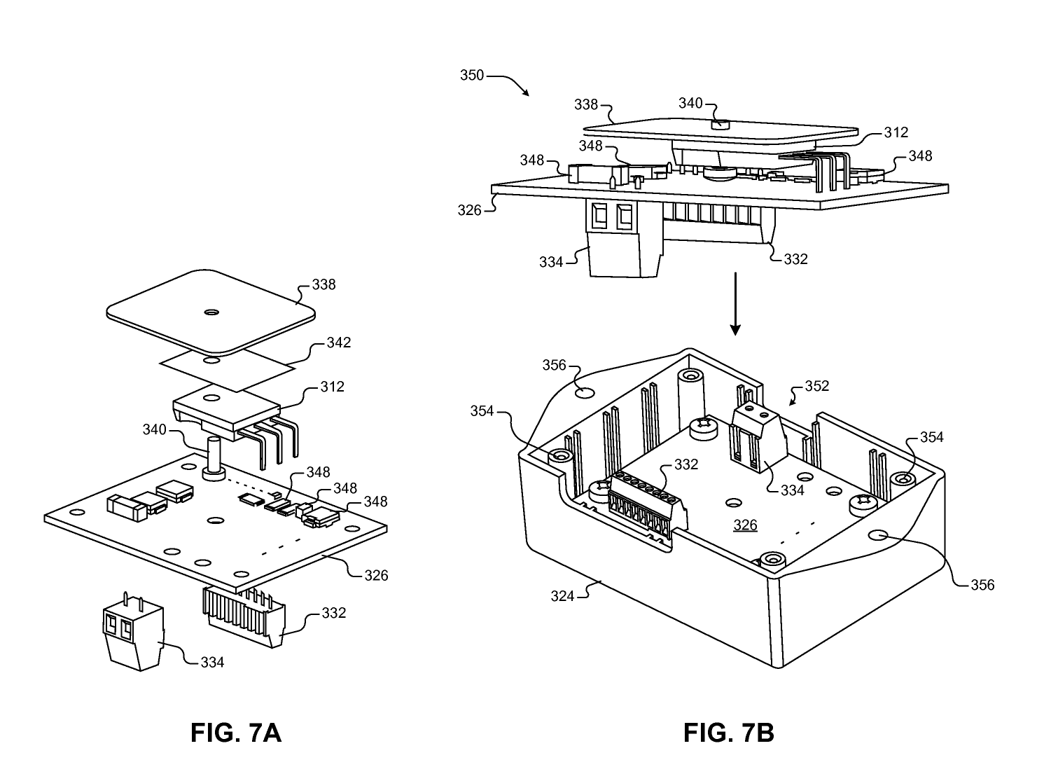

The electrical components of circuit 300 and circuit 301 of FIG. 3 and FIG. 5, respectively, may represent discrete packaged components included on a printed circuit board (PCB) in one example, as described with respect to FIGS. 6, 7A, and 7B. In other examples, the electrical components illustrated in circuits 300, 301 may represent components that are integrated into one or more integrated circuits. In still other examples, the electrical components of circuits 300, 301 may be fabricated as a combination of discrete and integrated components.

Power supply 304 is illustrated as a DC voltage source that supplies voltage V1. Power supply 304 may represent a battery in some examples. In other examples, power supply 304 may represent a battery and/or an AC/DC adapter that provides DC voltage from line power. In some examples, power supply 304 may provide 24VDC.

Fuse 306 may represent any discrete fuse component (e.g., a slow blow fuse). Electrical load 308 (hereinafter “heater 308”) illustrated as a resistive load, may represent a resistive heater as described above. Although electrical load 308 is described as a resistive heater, electrical load 308 may generally represent any other electrical load, such as a fan, cooling device, or any other environmental control device included in cabinet 100.

Thermostat switch 314 may represent any switching device described above with respect to FIG. 1. For example, thermostat switch 314 may include a bimetallic/mercury switch, or other suitable switch that opens/closes when subjected to varying temperatures. Thermostat switch 314 may be set to open/close near a set-point temperature, as described above. For example, thermostat switch 314 may be in an open state when the temperature within cabinet 100 is greater than the set-point temperature. Thermostat switch 314 may be in a closed state when the temperature within cabinet 100 is less than the set-point temperature.

Although thermostat switch 314 is illustrated and described as a single switch, thermostat switch 314 could also represent multiple switches within cabinet 100. For example, when multiple thermostat switches are included in cabinet 100, thermostat switch 314 could be replaced by one or more thermostat switches in series. In this example, all switches in series could be closed/open to indicate that the temperature within cabinet 100 is less/greater than the set-point temperature, yielding a similar result to the single thermostat switch 314.

Control switch 312 controls current through heater 308. In a closed state, control switch 312 connects power supply 304 to heater 308 to drive current through heater 308. In the example of FIG. 3, control switch 312 is arranged in series between heater 308 and power supply 304 such that the current, provided by power supply 304, through heater 308 and control switch 312 is the same when control switch 312 is in the closed state. In an open state, control switch 312 disconnects power supply 304 from heater 308. In the example of FIG. 3, control switch 312 is arranged in series with heater 308 so that when control switch 312 is in the open state, power supply 304 may not provide current through heater 308. Although control switch 312 is illustrated as an N-channel MOSFET (e.g., a power MOSFET) in FIG. 3 and FIG. 5, control switch 312 may be replaced by other semiconductor switches (e.g., a solid state relay switch).

In some examples, control switch 312 may also represent switches other than solid state semiconductor devices, such as an electro-mechanical relay switch, or other switches that function as described herein. In still other examples, control switch 312 may include a plurality of N-channel MOSFET devices arranged in parallel to accommodate for larger current draws through electrical load 308.

Control switch 312 may operate in the open or closed state, based on the voltage present at the gate of control switch 312. The voltage at the gate of control switch 312 may be referred to as the “gate voltage.” Other switches used in place of the N-channel MOSFET of FIG. 3 and FIG. 5 may be controlled by application of a voltage in a similar manner. For example, other semiconductor switches or relays may be controlled by a single control voltage.

In general, control switch 312, XNOR gate 318, and SCR 320 operate in a discrete manner. Control switch 312 may operate in an open state or a closed state, depending on a gate voltage applied to control switch 312. XNOR gate 318 may receive discrete input voltages and output a discrete voltage depending on the discrete input voltages. SCR 320 may operate in either an “off” or “on” state in response to a control voltage at node 305, labeled “SCR.” Discrete voltages may develop at nodes of circuits 300, 301, depending on the states of thermostat switch 314, control switch 312, XNOR gate 318, and SCR 320. These discrete voltages may generally be referred to as high or low. In FIG. 4, high and low voltages are represented as a “1” and “0,” respectively.

With respect to control switch 312, control switch 312 may operate in the closed state when the gate voltage of control switch 312 is high, e.g., greater than a threshold voltage of the MOSFET. Control switch 312 may operate in the open state when the gate voltage of control switch 312 is low (e.g., less than the threshold voltage of the MOSFET).

With respect to XNOR gate 318, XNOR gate 318 may output a high voltage when either both inputs are low or both inputs are high. XNOR gate 318 may output a low voltage when one input to XNOR gate 318 is low and the other input to XNOR gate 318 is high. XNOR gate 318 may represent any combination of circuit elements that perform the XNOR logic operation. For example, XNOR gate 318 may include discrete circuit components (e.g., discrete packaged transistors), or may include integrated components (e.g., transistors integrated as an integrated circuit).

With respect to SCR 320, SCR 320 may turn on (e.g., conduct current) when the voltage at node 305 is high (e.g., when the output of XNOR gate 318 is high). SCR 320 may turn off (e.g., not conduct current) when the voltage at node 305 is low (e.g., when the output of XNOR gate 318 is low).

In the closed state, control switch 312 may provide a low resistance path for current. Accordingly, when control switch 312 operates in the closed state, V1 may provide current through heater 308 and control switch 312. A voltage drop across control switch 312 (i.e., from source to drain) may be negligible (e.g., ≈0V) when control switch 312 is operating in the closed state. In the open state, control switch 312 may generally present a high resistance path to current, e.g., an open circuit. Accordingly, when control switch 312 operates in the open state, V1 may not provide current through heater 308 and control switch 312. A voltage drop across control switch 312 (i.e., from source to drain) may be approximately equal to V1 when control switch 312 is operating in the open state.

Heater 308 may generate heat when control switch 312 is in the closed state. In other examples, a different load other than heater 308 may be connected in place of heater 308 without affecting operation of circuit 300. For example, heater 308 may be replaced by a cooling device or a fan. Any other device in place of heater 308 may be actuated when control switch 312 is in the closed state. Heater 308 may not generate heat when control switch 312 is in the open state, but instead, heater 308 may cool down to ambient temperature in response to the reduction of current through heater 308. When heater 308 is replaced by another load, such as a fan, the fan may cease to operate when control switch 312 is in the open state.

Circuit 300 of FIG. 3 is illustrated as two separate circuits 300-1, 300-2. Circuit 300-1 includes power supply 304, fuse 306, heater 308, thermostat switch 314, and control switch 312. Additionally, circuit 300-1 includes diodes D1-D4, resistors R1-R3, capacitor C1, and SCR 320. Circuit 300-2 may represent the “fault detection circuit” described above with respect to FIG. 1. Circuits 300-1, 300-2 include nodes XNOR1, XNOR2, and SCR that illustrate interconnections between circuits 300-1, 300-2.

The functionality of circuit 300-1 will now be described. Diodes D1 and D2 may provide protection against electrostatic discharge (ESD). Diode D4 may provide protection against ESD at the gate of control switch 312. Diode D3 may set the gate voltage when thermostat switch 314 is closed.

Resistor R1 is selected to control the amount of current provided to D3 when thermostat switch 314 is closed. Resistor R2 and capacitor C1 may provide filtering in order to reduce ringing, e.g., when thermostat switch 314 is closed/opened. For example, the opening and closing of thermostat switch 314 could cause a “ringing” at the gate of control switch 312 if R2 and C1 were not present. Accordingly, values for R2 and C1 may be selected so that ringing in the gate voltage is damped.

Resistor R3 may drain charge off of C1 and the gate capacitance of control switch 312 upon opening of thermostat switch 314. The size of resistor R3 may be selected such that it does not divide the voltage at node XNOR2 to an extent that affects the gate voltage of control switch 312. For example, R3 may be selected relative to R2 so that when thermostat switch 314 is closed, a sufficient gate voltage is present at control switch 312 to cause control switch 312 to operate in the closed state.

SCR 320 is controlled by the voltage at node SCR. The voltage present at node SCR is set by fault detection circuit 300-2. Fault detection circuit 300-2 includes XNOR gate 318, resistors R4-R7, and diodes D5-D6. Resistor R4 and Zener diode D5 may regulate the voltage used to power XNOR gate 318. For example, the resistor R4 may set the current through Zener diode D5 which may in turn set the operating voltage for XNOR gate 318 at the Zener voltage of Zener diode D5. Node V1 of circuit 300-2 may be connected to power supply 304 prior to fuse 306, so that when fuse 306 is blown, power may still be supplied to XNOR gate 318.

Resistor R5 and Zener diode D6 may set the voltage at a first input of XNOR gate 318. For example, the resistor R4 may set the current through Zener diode D5 which may in turn set the voltage at the first input of XNOR gate 318. When the voltage at node XNOR1 is high (1), the first input of XNOR gate 318 may be high (1). When the voltage at node XNOR1 is low (0), the first input of XNOR gate 318 may be low (0).

Node XNOR2 provides a second input to XNOR gate 318. The voltage at node XNOR2 is high (1) when thermostat switch 314 is closed, and, therefore, the second input to XNOR gate 318 is high (1) when thermostat switch 314 is closed. The voltage at node XNOR2 is low (0) when thermostat switch 314 is open, and, therefore, the second input to XNOR gate 318 is low (0) when thermostat switch 314 is open.

Output of XNOR gate 318 is based on the first and second inputs to XNOR gate 318. For example, XNOR gate 318 may implement an XNOR logical operation based on the first and second inputs to XNOR gate 318. XNOR gate 318 may generate a high (1) output when both first and second inputs to XNOR gate 318 are the same. XNOR gate 318 may generate a low (0) output when one of first and second inputs to XNOR gate 318 is low, and the other of first and second inputs is high.

The voltage output from XNOR gate 318 may be divided by resistors R6 and R7 to produce a voltage at node SCR. The voltage at node SCR controls the state of SCR 320. When the voltage at node SCR is greater than an SCR threshold voltage (1), SCR 320 may form a short circuit. When the voltage at node SCR is less than the SCR threshold voltage (0), SCR 320 may form an open circuit. The voltage at node SCR may be greater/less than the SCR threshold voltage when the output of XNOR gate 318 is high/low. In some examples, the SCR threshold voltage may be approximately 1.6V, depending on the type of SCR selected.

The voltage output from XNOR gate 318 may be received by monitoring module 117 in some examples. In response to a high output voltage, monitoring module 117 may perform a control action. For example, in response to a high output voltage, monitoring module 117 may turn off cabinet electronics 102.

FIG. 4 illustrates a table 322 that summarizes the operation of circuit 300 in four different states. The top two rows of table 322 summarize operation of circuit 300 when the environmental temperature is less than the set-point temperature of thermostat switch 314. The first row illustrates operation of circuit 300 when control switch 312 is functional. The second row illustrates operation of circuit 300 when there is a fault in control switch 312. The bottom two rows of table 322 summarize operation of circuit 300 when the environmental temperature is greater than the set-point temperature of thermostat switch 314. The third row in table 322 illustrates operation of circuit 300 when there is a fault in control switch 312. The bottom row of table 322 illustrates operation of circuit 300 when control switch 322 is functional.

The first row of table 322 summarizes operation of circuit 300 as follows. When the environmental temperature is less than the set-point temperature of thermostat switch 314, thermostat switch 314 is closed. If control switch 312 is functional, control switch 312 is closed. The voltages at nodes XNOR1 and XNOR2 are low and high, respectively. Based on the low and high inputs to XNOR gate 318, XNOR gate 318 sets node SCR to a low voltage (e.g., 0V), and therefore, SCR 320 remains off (i.e., a high resistance path).

The second row of table 322 summarizes operation of circuit 300 as follows. When the environmental temperature is less than the set-point temperature of thermostat switch 314, thermostat switch 314 is closed. Control switch 312 does not close when a fault is present in control switch 312. Instead, control switch 312 may form a permanently open circuit. The voltages at nodes XNOR1 and XNOR2 are both at high levels. Based on the high inputs to XNOR gate 318, XNOR gate 318 sets node SCR to a high level, and therefore SCR 320 turns on. When SCR 320 is on, a low resistance path is formed and power supply 304 provides a large amount of current through SCR 320. For example, SCR 320 may be selected such that when SCR 320 is on, the current delivered through SCR 320 is greater than a breaking current of fuse 306. In some examples, fuse 306 may be rated to approximately 125%-150% of maximum operating current.

The third row of table 322 summarizes operation of circuit 300 as follows. When the environmental temperature is greater than the set-point temperature of thermostat switch 312, thermostat switch 312 is open. Control switch 312 does not open when a fault is present in control switch 312. Instead, control switch 312 may form a permanently shorted circuit. The voltages at nodes XNOR1 and XNOR2 are both at low levels (e.g., 0V). Based on the low voltage inputs to XNOR gate 318, XNOR gate 318 sets node SCR to a high level, and therefore SCR 320 turns on. When SCR 320 is on, a low resistance path is formed and power supply 304 provides a large amount of current through SCR 320 that causes fuse 306 to blow.

The fourth row of table 322 summarizes operation of circuit 300 as follows. When the environmental temperature is greater than the set-point temperature of thermostat switch 314, thermostat switch 314 is open. If control switch 312 is functional, control switch 312 is open. The voltages at nodes XNOR1 and XNOR2 are high and low, respectively. Based on the high and low inputs to XNOR gate 318, XNOR gate 318 sets node SCR to a low level, and therefore, SCR 320 remains off FIG. 5 is a schematic that includes an example fault indicator circuit that may connect across fuse 306 at nodes F1 and F2. Although the fault indicator circuit is not included in FIG. 3, and nodes labeled F1 and F2 are not illustrated in FIG. 3, the fault indicator circuit described with respect to FIG. 5 may be connected to circuit 300 of FIG. 3.

The fault indicator circuit includes diodes D7 and D8, resistor R8, and LED D9. When fuse 306 forms a closed circuit, current may flow through diode D8 and resistor R8. Upon blowing of fuse 306, node F2 may be disconnected from power supply 304, causing current to shunt through diode D7 and LED D9 to ground, which in turn causes LED D9 to emit light. R8 may be selected to regulate the amount of current drawn through LED D9. LED D9 may be located in cabinet 100 such that the light emitted from LED D9 is readily visible to user who is inspecting cabinet 100.

FIG. 6 is a block diagram of an example packaging arrangement of some components included in circuit 300. Some components illustrated in FIG. 3 and FIG. 5 may be included in an enclosure 324, while other components illustrated in FIG. 3 and FIG. 5 may be housed in cabinet 100 external to enclosure 324. Enclosure 324 may include a metal or plastic enclosure configured to receive a printed circuit board 326 (PCB) that includes various electronic components. Packaging of some components within an enclosure (e.g., enclosure 324) may provide a modular system that may be easily installed into already existing cabinets that include thermostats, heaters, and power supplies.

In the example of FIG. 6, power supply 304 may be placed within cabinet 100 along with thermostat switch 314, heater 308, cabinet electronics 102, and fault indicator 116. Power supply 304, thermostat switch 314, heater 308, fault indicator 116, and monitoring module 117 may be connected to PCB 326 included within enclosure 324 using wires 328-1, 328-2, 328-3, 328-4, 328-5 (collectively “wires 328”). For example, wires 328 may be fed through enclosure 324 and connected (e.g., screwed or soldered) to PCB 326. PCB 326 includes a power supply connector 330, thermostat connector 332, and a heater connector 334 that receive wires 328-1, 328-2, 328-3 and connect power supply 304, thermostat switch 314, and heater 308 to components included on PCB 326. Connectors 330, 332, 334 may include terminal blocks having screws that securely grip wires 328. Connectors 330, 332, 334 may also include metal contacts on PCB 326 to which wires 328 may be soldered.

PCB 326 may be mounted within enclosure 324. PCB 326 may include control switch 312, XNOR gate 318, SCR 320, fuse 306, and other electronic components 336 (e.g., resistors R1-R8, capacitor C1, and diodes D1-D9). PCB 326 may represent any structure used to mechanically support and electrically connect control switch 312, XNOR gate 318, SCR 320, fuse 306, other electronic components 336, and connectors 330, 332, 334. PCB 326 may include one or more layers of conductive traces and conductive vias that provide electrical connections between these components.

FIGS. 7A and 7B show three-dimensional views of an example enclosure 324 of FIG. 6 including PCB 326 and a variety of electrical components. FIG. 7A shows an exploded view of the components connected to PCB 326. Control switch 312 may be connected to heatsink 338 using a connector 340 (e.g., a screw). A thermally conductive, and in some examples, electrically insulating, intermediate layer 342 may be placed between heatsink 338 and control switch 312 in order to promote heat dissipation from control switch 312 to heatsink 338. In some examples, intermediate layer 342 may comprise a silicone pad.

Heater connector 334 is illustrated as a terminal block that receives wires 328-1. Heater connector 334 may include screws that secure wires 328-1 in place. Thermostat connector 332 is illustrated as a terminal block that receives wires 328-2. Thermostat connector 332 may include screws that secure wires 328-2. Thermostat connector 332, as illustrated, includes 8 receptacles for receiving 8 wires. Accordingly, thermostat connector 332 may be configured to receive more than one thermostat switch 314 in some examples. For example, when cabinet 100 includes 4 separate thermostat switches, thermostat connector 332 may receive the four separate thermostat switches. Operation of circuit 300 including more than one thermostat switch, e.g., more than just thermostat switch 314, is described above with respect to FIG. 3. Fuse 306, XNOR gate 318, SCR 320, and other electronic components 336 may be arranged on PCB 326 and interconnected according to FIG. 3. Fuse 306, XNOR gate 318, SCR 320, and other electronic components 336 are generally referenced as 348.

The upper portion of FIG. 7B illustrates an assembly 350 of the exploded components of FIG. 7A. Assembly 350 may be turned over and placed into enclosure 324. Referring now to the lower portion of FIG. 7B, PCB 326 may be screwed into enclosure 324. Slots (e.g., slot 352) defined by enclosure 324 may provide a feedthrough through which wires 328 may be connected to heater connector 334, thermostat connector 332, and power supply connector 330. Although power supply connector 330 is not illustrated in FIG. 7 as a terminal block, power supply connector 330 may comprise metal contacts on PCB 326 to which wires 328-1 may be soldered.

A lid (not shown) may be fastened to enclosure 324 using bolts. For example, the lid may be bolted to enclosure 324 at the threaded portions 354 of enclosure 324. Regardless of whether the lid is fastened to enclosure 324, enclosure 324 may be fastened to a structure within cabinet 100, e.g., a wall of cabinet 100. For example, bolts may be inserted through mounting holes 356 defined in enclosure 324, and subsequently fastened to the structure within cabinet 100, e.g., to threaded mounts within cabinet 100.

Although circuit 300 is illustrated and described above as a circuit that controls a resistive heater used to control temperature in an electronics cabinet, circuit 300 may be used in other high wattage applications in which fault monitoring functionality may be beneficial. For example, circuit 300 may be used in other high wattage temperature control applications, e.g., any application in which a high wattage heater is used.

Although a few examples have been described in detail above, other modifications are possible. For example, the flow diagram depicted in the figures does not require the particular order shown, or sequential order, to achieve desirable results. Other steps may be provided, or steps may be eliminated, from the described flow diagram, and other components may be added to, or removed from, the described systems. Other embodiments may be within the scope of the following claims.

1. A system comprising:
a control switch configured to:
drive current through an electrical load in a closed state; and
disconnect the electrical load from a power supply in an open state; and
a control module configured to:
connect to a thermostat switch that operates in one of an open state or a closed state based on a temperature of the thermostat switch;
control a state of the control switch based on a state of the thermostat switch; and
detect a fault in the control switch based on the state of the thermostat switch and a voltage across the control switch.

2. The system of claim 1, further comprising a fuse configured to provide a path for current through the electrical load when the control switch is in the closed state.

3. The system of claim 2, wherein the control module is configured to blow the fuse when the control module detects the fault, wherein the electrical load is disconnected from the power supply when the fuse is blown.

4. The system of claim 1, wherein the control module includes a fault detection circuit that receives a first input voltage that is based on the state of the thermostat switch, that receives a second input voltage that is based on the voltage across the control switch, and that generates an output voltage that indicates whether the control module detects the fault in the control switch.

5. The system of claim 4, further comprising a fuse configured to provide a path for current through the electrical load when the control switch is in the closed state, wherein the control module is configured to blow the fuse based on the output voltage, and wherein the electrical load is disconnected from the power supply when the fuse is blown.

6. The system of claim 5, further comprising a silicon controlled rectifier (SCR) coupled to the fuse, wherein the output voltage controls the state of the SCR, and wherein the output voltage controls the SCR to blow the fuse when the fault is present in the control switch.

7. The system of claim 4, wherein the fault detection circuit comprises an exclusive NOR gate that:
receives the first and second input voltages; and
generates the output voltage based on the first and second input voltages.

8. The system of claim 7, further comprising a fuse configured to provide a path for current through the electrical load when the control switch is in the closed state, wherein the control module is configured to blow the fuse based on the output voltage, and wherein the electrical load is disconnected from the power supply when the fuse is blown.

9. The system of claim 8, further comprising a silicon controlled rectifier (SCR) coupled to the fuse, wherein the output voltage controls the state of the SCR, and wherein the output voltage controls the SCR to blow the fuse when the fault is present in the control switch.

10. The system of claim 1, wherein the control switch comprises a semiconductor device or an electro-mechanical switch.

11. The system of claim 10, wherein the control switch includes a transistor.

12. The system of claim 11, wherein the transistor includes a metal-oxide-semiconductor field-effect transistor (MOSFET), wherein the control module controls a gate voltage of the MOSFET to control the state of the MOSFET based on the state of the thermostat switch, and wherein the fault in the control switch includes one of a short circuit between the source and drain of the MOSFET and an open circuit between the source and drain of the MOSFET.

13. The system of claim 1, wherein the fault includes one of a short circuit in the control switch and an open circuit in the control switch.

14. The system of claim 1, wherein the electrical load is a resistive heater.

15. A system comprising:
a transistor configured to:
connect to an electrical load;
drive current through the electrical load in a closed state; and
disconnect the electrical load from a power supply in an open state; and
a circuit configured to:
connect to a thermostat switch that operates in one of an open state or a closed state based on a temperature of the thermostat switch;
provide a control voltage to the transistor based on a state of the thermostat switch, wherein the control voltage sets the state of the transistor; and
detect a fault in the transistor based on the state of the thermostat switch and a voltage drop across the transistor.

16. The system of claim 15, wherein the circuit comprises a logic gate that receives a first input voltage that is based on the state of the thermostat switch, that receives a second input voltage that is based on the voltage drop across the transistor, and that generates an output voltage that indicates whether the fault is detected in the transistor.

17. The system of claim 16, wherein the logic gate is an exclusive NOR gate.

18. The system of claim 16, further comprising:
a fuse that couples the power supply to the electrical load; and
a silicon controlled rectifier (SCR), wherein the output voltage controls a state of the SCR, and wherein the output voltage controls the SCR to blow the fuse when the fault is present in the control switch.

19. A method comprising:
determining a state of a thermostat switch, wherein the thermostat switch operates in one of an open state or a closed state based on a temperature of the thermostat switch;
setting a state of a control switch based on the determined state of the thermostat switch, wherein the control switch drives current through an electrical load in a closed state, and wherein the control switch disconnects the electrical load from a power supply in an open state; and
detecting a fault in the control switch based on the determined state of the thermostat switch and a voltage across the control switch.

20. The method of claim 19, wherein setting the state of the control switch comprises generating a control voltage that controls the state of the control switch, wherein detecting the fault comprises performing an exclusive NOR operation on a first input voltage and a second input voltage to generate an output voltage that indicates whether the fault is present in the control switch, wherein the first input voltage is based on the control voltage, and wherein the second input voltage is based on the voltage across the control switch.
